(19) United States
(12) Patent Application Publication
(10) Pub. No.: US 2021/0209714 A1
(43) Pub. Date: Jul. 8, 2021

(54) PASSENGER BOARDING SYSTEM

(71) Applicant: Omer Kropf, Syracuse, IN (US)

(72) Inventor: Omer Kropf, Syracuse, IN (US)

(21) Appl. No.: 17/142,368

(22) Filed: Jan. 6, 2021

Related U.S. Application Data
(60) Provisional application No. 62/957,452, filed on Jan. 6, 2020.

(51) Int. Cl. G06Q 50/30; B64F 1/31

(52) U.S. Cl. CPC G06Q 50/30; B64F 1/31

(57) ABSTRACT

A method for boarding passengers on a vehicle that includes providing an organization area and a passenger vehicle, the passenger vehicle having a plurality of rows between a front row and a back row, positioning a passenger display in the organization area, displaying, on the passenger display, a boarding pattern identifying a first group and a second group for boarding passengers onto the passenger vehicle, and instructing passengers to exit the organization area and enter the passenger vehicle in the boarding pattern identified by the passenger display. The first group is directed to occupy a first set of rows before the second group is directed to occupy a second set of rows and two adjacent rows of the first set of rows are separated from one another by at least one row of the second set of rows.

### CROSS-REFERENCE TO RELATED APPLICATION

The present disclosure claims the benefit of U.S. Provisional Application No. 62/957,452 filed Jan. 6, 2020, the contents of which are hereby incorporated herein in entirety.

### TECHNICAL FIELD

The present teachings are related to systems and methods for boarding a vehicle, and in particular systems and methods for quickly and efficiently directing a group to board a passenger vehicle.

### BACKGROUND

The transportation industry routinely requires large groups of passengers to sit in a passenger vehicle in assigned locations. Often, this involves separating the individual passengers from a larger crowd and directing the passengers to enter the passenger vehicle and identify their assigned location. The transportation industry relies on the passenger vehicles being filled with passengers in a timely manner to ensure deadlines are met and that the passenger vehicle arrives at an end location in a timely manner. Current systems of directing passengers to board the passenger vehicle often result in a slow boarding process that causes unnecessary delays in the transportation process.

Often, passengers are directed to board the transportation vehicle in the order in which they will be sitting in the vehicle. This method results in bottlenecks and other delays as users occupy a small aisle of the passenger vehicle while loading any luggage or articles brought with the passenger. Further, often passengers in adjacent rows are trying to stow luggage and the like in designated areas while boarding, causing further delays in the boarding process. These delays cost the transportation industry time and money.

### SUMMARY

One embodiment is a method for boarding passengers on a vehicle. The method includes providing an organization area and a passenger vehicle, the passenger vehicle having a plurality of rows between a front row and a back row, positioning a passenger display in the organization area, displaying, on the passenger display, a boarding pattern identifying a first group and a second group for boarding passengers onto the passenger vehicle, and instructing passengers to exit the organization area and enter the passenger vehicle in the boarding pattern identified by the passenger display. Wherein, the first group is directed to occupy a first set of rows before the second group is directed to occupy a second set of rows and two adjacent rows of the first set of rows are separated from one another by at least one row of the second set of rows.

In one example of this embodiment, the first set of rows are substantially evenly spaced from one another between the front row and the back row. In one aspect of this embodiment, the second set of rows are substantially evenly spaced from one another between the front row and the back row. In one aspect of this example, the first and second set of rows are spaced from one another to have the same number of rows positioned between adjacent rows of the corresponding first and second set of rows.

In another example, the boarding pattern instructs all passengers of the first group to board the passenger vehicle through a vehicle boarding entrance before instructing the second group to board the passenger vehicle. In yet another example the first group is arranged in a first order so a first passenger of the first group on the passenger vehicle occupies at least one seat in a row furthest from the vehicle boarding entrance of the first group. In one aspect of this example the first order further organizes the remaining passengers of the first group so passengers in rows of the first set of rows biased towards the row furthest from the vehicle boarding entrance enter the passenger vehicle before passengers in rows biased nearest the vehicle boarding entrance. In part of this aspect the second group is arranged in a second order so a first passenger of the second group on the passenger vehicle occupies at least one seat in the row furthest from the vehicle boarding entrance of the second group. In a section of this part the second order further organizes the remaining passengers of the second group so passengers in rows of the second set of rows biased towards the row furthest from the vehicle boarding entrance enter the passenger vehicle before passengers in rows biased towards the row nearest the vehicle boarding entrance.

Another example has a row from the second set of rows positioned between each adjacent set of rows of the first set of rows. In yet another example, the boarding pattern includes a third group having a third set of rows for boarding passengers onto the passenger vehicle. One aspect of this example has a row from the third set of rows positioned between each adjacent set of rows of the first set of rows. In another aspect of this example the boarding pattern includes a fourth group, a fifth group, and a sixth group for boarding passengers onto the passenger vehicle. In one part of this aspect the boarding pattern is arranged such that the first group boards the passenger vehicle, then the second group boards the passenger vehicle, then the third group boards the passenger vehicle, then the fourth group boards the passenger vehicle, then the fifth group boards the passenger vehicle, and finally the sixth group boards the passenger vehicle.

In yet another example the passenger display has a first side and a second side, wherein the first side identifies the first group and the second side identifies the second group thereby instructing passengers from the first group to organize along the first side and passengers from the second group to organize on the second side. In one aspect of this example the passenger display displays a first order associated with the first group on the first side and a second order associated with the second group on the second side. Wherein both the first and second orders are arranged so passengers in rows further from the vehicle boarding entrance enter before passengers in rows towards the vehicle boarding entrance. In part of this aspect, the boarding pattern includes a third group having a third order for boarding passengers onto the passenger vehicle and the passenger display displays the third group and third order on the first side after the first group has substantially boarded the passenger vehicle. In yet another part, the boarding pattern includes a fourth group having a fourth order for boarding passengers onto the passenger vehicle and the passenger display displays the fourth group and fourth order on the second side after the second group has substantially boarded the passenger vehicle. In another part, the boarding pattern includes additional groups that are displayed on the passenger display in an alternating pattern as subsequent groups board the passenger vehicle.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an illustrative view of a passenger transport facility;

FIG. 2 is a schematic representation of a seating chart for a passenger vehicle;

FIG. 3a is a schematic representation of the seating chart of FIG. 1 with a first group seated;

FIG. 3b is a schematic representation of the seating chart of FIG. 3a with the addition of a second group seated;

FIG. 3c is a schematic representation of the seating chart of FIG. 3b with the addition of a third group seated;

FIG. 3d is a schematic representation of the seating chart of FIG. 3c with the addition of a fourth group seated;

FIG. 3e is a schematic representation of the seating chart of FIG. 3d with the addition of a fifth group seated;

FIG. 3f is a schematic representation of the seating chart of FIG. 3e with the addition of a sixth group seated;

FIG. 4 is an elevated perspective view of a plurality of passenger displays;

FIG. 5a is a schematic view of a passenger display from FIG. 4 showing a first display configuration;

FIG. 5b is a is a schematic view of a passenger display from FIG. 4 showing a second display configuration;

FIG. 5c is a is a schematic view of a passenger display from FIG. 4 showing a third display configuration;

FIG. 5d is a is a schematic view of a passenger display from FIG. 4 showing a fourth display configuration;

FIG. 5e is a is a schematic view of a passenger display from FIG. 4 showing a fifth display configuration; and

FIG. 5f is a is a schematic view of a passenger display from FIG. 4 showing a sixth display configuration.

Corresponding reference numerals are used to indicate corresponding parts throughout the several views.

### DETAILED DESCRIPTION

The above-mentioned aspects of the present application and the manner of obtaining them will become more apparent and the teachings of the present application itself will be better understood by reference to the following description of the embodiments of the present application taken in conjunction with the accompanying drawings.

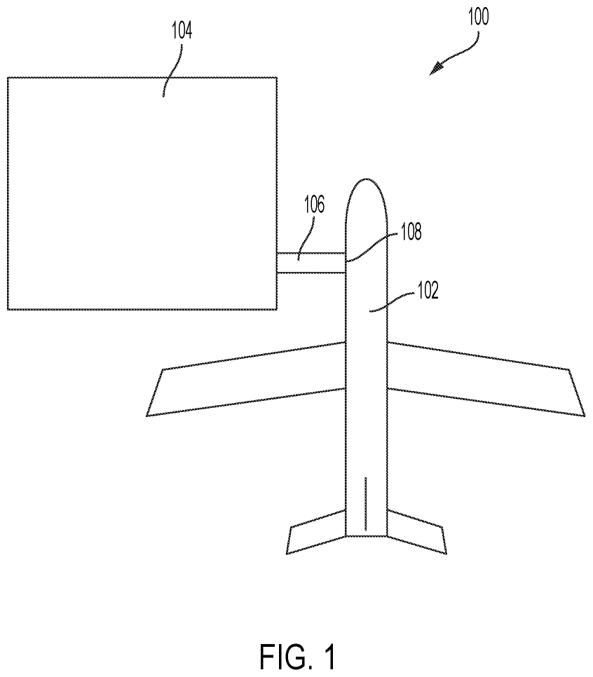

Referring now to FIG. 1, a passenger transport facility 100 is illustrated. The passenger transport facility 100 may be any facility that acts as a hub for a transportation industry to gather and organize passengers for transportation on a passenger vehicle 102. In one non-exclusive example of this disclosure, the passengers transport facility 100 may have an organization area 104 wherein passenger are intended to congregate and organize prior to boarding the passenger vehicle 102.

In the non-exclusive example of FIG. 1, the organization area 104 may be an airport terminal and the passenger vehicle 102 may be an airplane or the like. In this configuration, a bridge 106 may provide access from the terminal to the airplane as is known in the transportation industry. While the exemplary embodiment of FIG. 1 illustrates a terminal as the organization area 104 and an airplane as the passenger vehicle 102, this disclosure contemplates implementing the teachings discussed herein in any transportation industry wherein the passenger vehicle has rows or the like with assigned seating. More specifically, this disclosure may also be applied to train stations, bus stations, subways, or any other known passenger transportation facility.

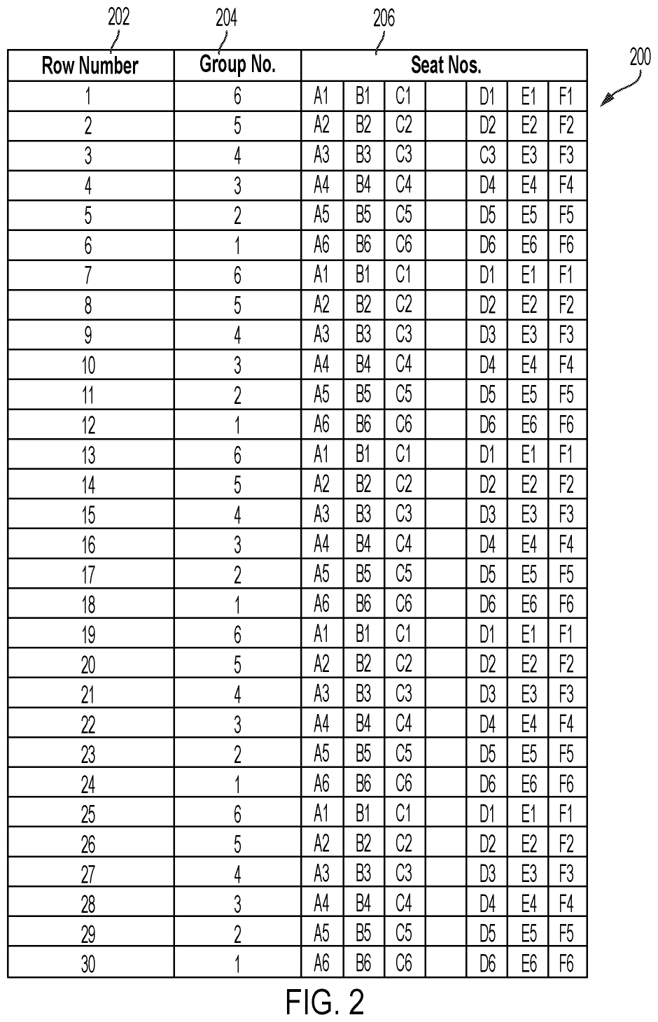

Referring now to FIG. 2, a schematic representation of a seating chart 200 is illustrated. The seating chart 200 may be representative of an airplane seating chart but is meant only as one non-exclusive example and the teachings discussed herein may be applied to seating charts having different configurations as would be appreciated by a person having skill in the relevant art. The seating chart 200 may have a row number column 202 wherein the rows are numbered sequentially. In the non-exclusive example of FIG. 2 row 1 may be the front most row and row 30 may be the back most row.

The seating chart 200 may also have a group number column 204. The group number column 204 may represent the group in which each corresponding row has been assigned. In the non-exclusive example of FIG. 2, there are six (6) different groups distributed along the rows. The groups may be assigned sequentially and repeatedly from the front row 1 towards the back row 30 until all of the rows have been assigned a group.

FIG. 2 may also illustrate a seat number column 206 wherein each of the seat numbers of a row are given a letter designating their position in the corresponding row as is known in art. In the exemplary embodiment of FIG. 2, the letter designating each seat location is accompanied by a number indicating the group assigned to that particular seat. Accordingly, seat A from row 15 is labelled “A4” because it is in the fourth group. While a specific seat chart is illustrated herein labelling the specific seats with their corresponding group, this disclosure is not limited to such a configuration and any labelling strategy may be implemented to practice the teachings discussed herein. For example, each seat may simply have a single designation to indicate the row/seat number/group of the specific seat. In the example of Seat A4 from row 15, the seat may simply be labelled as “15A4.” Accordingly, this disclosure contemplates implementing any naming convention capable of identifying the row, seat position, and group of any particular seat on the passenger vehicle.

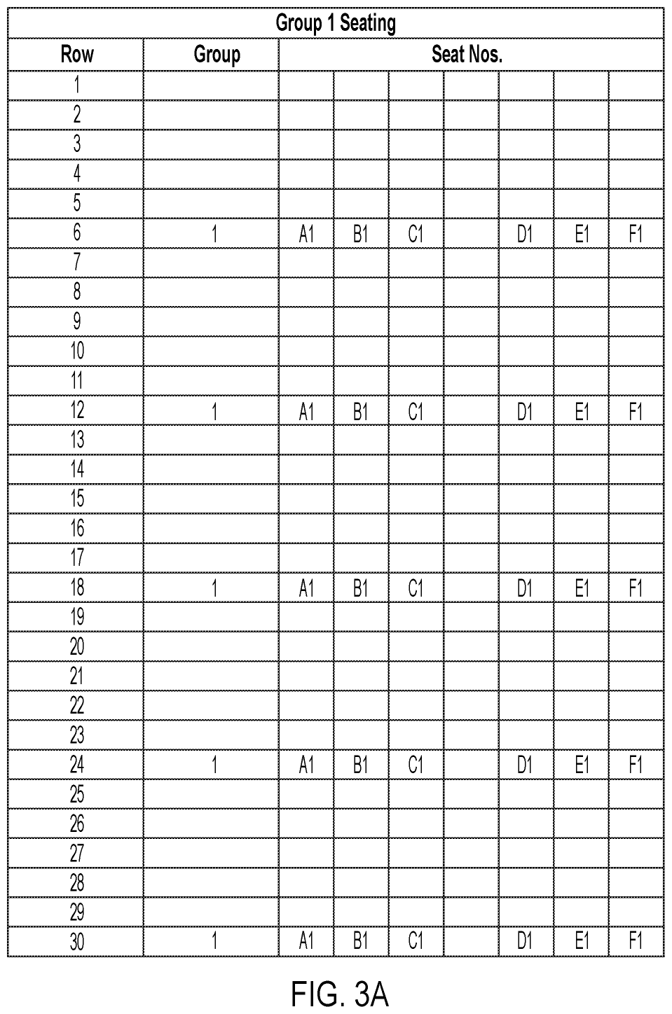

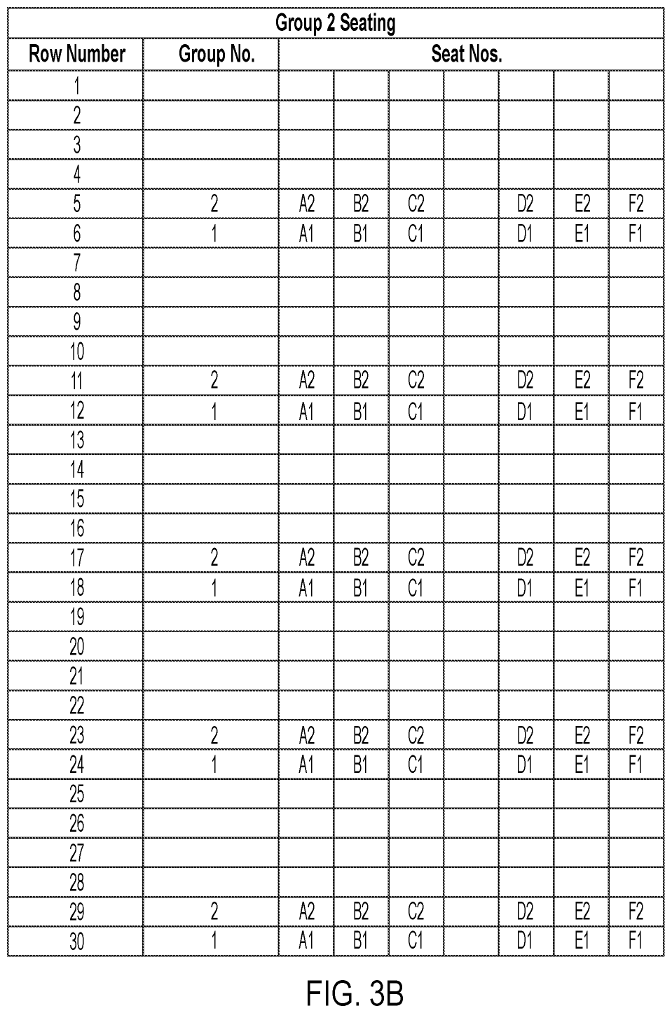

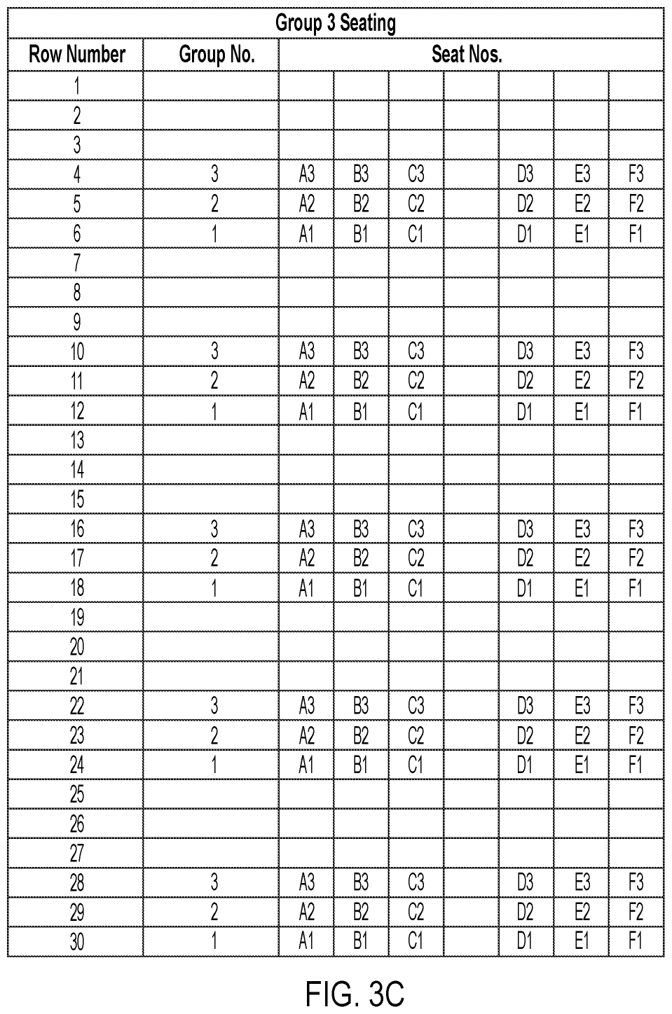

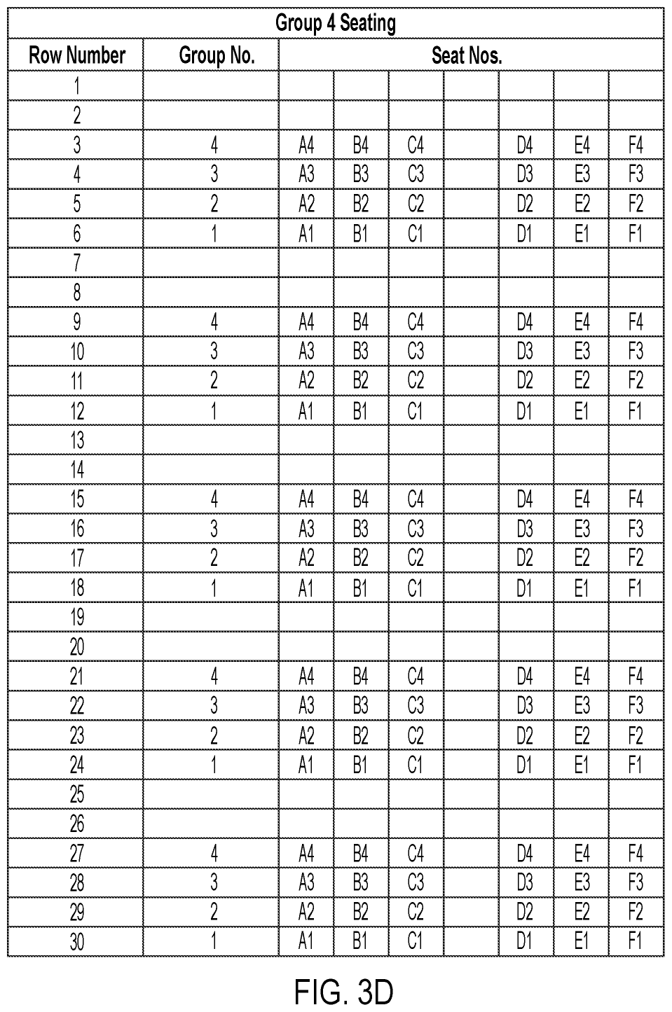

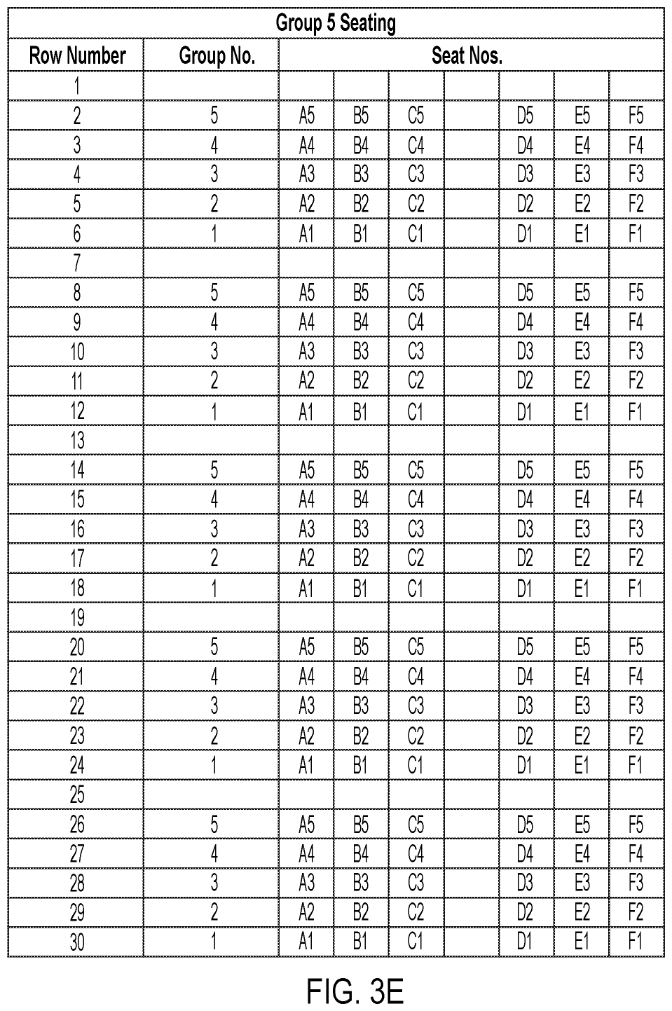

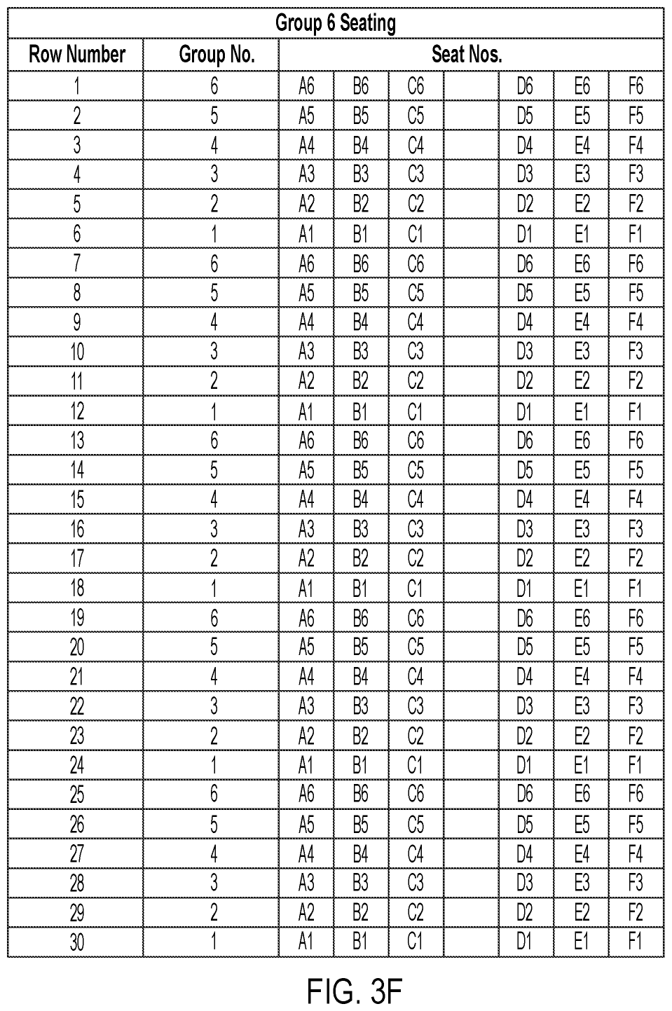

As discussed in more detail herein, FIGS. 3a-3f illustrate one boarding method contemplated herein that utilizes the groups from the group column 204 to provide a boarding pattern for passengers to board the passenger vehicle 102. More specifically, FIG. 3a is a schematic representation of the occupied seats of the passenger vehicle 102 after the first group has been instructed to board. In FIG. 3a, the seat numbers column 206 is left blank for seats that have not yet been allowed to board (i.e. are not part of group 1). Further still, the seats that are intended to be occupied after group 1 boards the passenger vehicle 102 are identified by having the seat/group number placed therein. Similar representations are given for FIGS. 3b-3f.

In FIG. 3a, group 1 has been directed to board the vehicle 102 when substantially all of the seats were vacant. That is to say, group 1 is the first group of passengers on the vehicle 102. Group 1 may further be ordered in a first order prior to boarding the vehicle 102 in the organization area 104. If a vehicle boarding entrance 108 is substantially at the front of the vehicle, the first order may be organized so that the first passengers on the vehicle from group 1 are the passengers on the back most row of the group (i.e. row 30). The first order may further be organized so the next passengers of group 1 are the passengers that occupy the next back most row of group 1 (i.e. row 24). The order of passengers may be organized so that the back most passengers of the group enter the vehicle first thereby ensuring that all passengers access their respective rows prior to stowing baggage and the like.

In one embodiment, the vehicle boarding entrance 108 is located substantially at the back of the vehicle, and the first order may be organized so that the first passengers on the vehicle from group 1 are the passengers in the front most row of group 1 (row 1). The first order may further be organized so the next passengers of group 1 are the passengers that occupy the next front most row of group 1 (i.e. row 7). The order of passengers may be organized so that the front most passengers of the group enter the vehicle first thereby ensuring that all passengers access their respective rows prior to stowing baggage and the like.

In another embodiment, the vehicle boarding entrance 108 is located substantially at the middle vehicle. In this embodiment, the first order may be organized so that the first passengers on the vehicle from group 1 are the passengers in the front most row (row 1). The first order may further be organized so the next passengers of group 1 are the passengers that occupy the back most row (row 30). The order of passengers will continue to alternate between the front most and back most rows in the associated groups. Alternatively, the first order may be organized so the first passengers on the vehicle from group 1 are the passengers in the back most row of the group (row 30), and the next passengers of group 1 occupy the front most row of group 1 (row 1). This order of passengers will continue to alternate between the front most and back most rows in the associated group.

Also illustrated in FIG. 3a is the spacing of adjacent rows of the group 1 when the vehicle boarding entrance 108 is at the front of the vehicle. That is to say, the back most row of group 1 (row 30), is spaced six rows behind the adjacent row (row 24). The back most row of group one (row 30) is seated first, followed by the adjacent row (row 24). The remaining rows of group 1 are similarly spaced from one another. In this configuration, each passenger of the group may access their assigned rows while having at least one buffer row between their row and the adjacent row of group 1. In this configuration, the passengers of group 1 will have space to stow luggage and the like because passengers are not simultaneously trying to occupy the immediately adjacent rows.

After group 1 has exited the organization area 104 and entered the vehicle 102, group 2 may be allowed to leave the organization area and enter the vehicle. Group 2 may be entering the vehicle 102 after group 1 has been substantially seated in their corresponding seats and the passengers from group 1 thereby no longer obstruct the passengers from group 2. Further, group 2 may also be organized in a second order wherein the passengers in group 2 that occupy the rows furthest from the vehicle boarding entrance 108 of the group enter the vehicle 102 first and the passengers in group 2 that occupy the rows closest to the vehicle boarding entrance 108 enter the vehicle 102 last. The passengers in group 2 may be assigned to rows that are similarly spaced from one another as group 1 to thereby provide plenty of room between adjacent rows of group 2 to allow the passengers to stow baggage and become situated in their respective assigned seats in a similar way as described above for group 1.

This process may be substantially repeated until all of the seats of the vehicle 102 are filled with passengers. More specifically, group 3 may be allowed to board the vehicle 102 after group 2 has left the organization area 104 (see FIG. 3c), group 4 may be allowed to board the vehicle 102 after group 3 has left the organization area 104 (see FIG. 3d), group 5 may be allowed to board the vehicle 102 after group 4 has left the organization area 104 (see FIG. 3e), and group 6 may be allowed to board the vehicle 102 after group 5 has left the organization area 104 (see FIG. 3f). After group 6 has entered the vehicle 102, all of the passenger seats may be filled and the vehicle may depart to the intended destination.

While six groups are illustrated herein, this disclosure contemplates using more or fewer groups depending on the type of passenger vehicle 102 being used among other things. In one embodiment, there may be only two groups. In this configuration, every other row is assigned to alternating groups to allow at least a one-row buffer between passengers as they board. Alternatively, other embodiments have more than six groups wherein there are more than five rows between adjacent rows of the groups. In one non-exclusive example, the number of rows between adjacent rows of a group may depend on the number of seats in each row. More specifically, if a row has eight (8) seats therein, more groups may be required to generate a larger buffer of rows to ensure passengers have plenty of space. Alternatively, if a row only has 2 seats fewer groups may be required because fewer passengers are in each row.

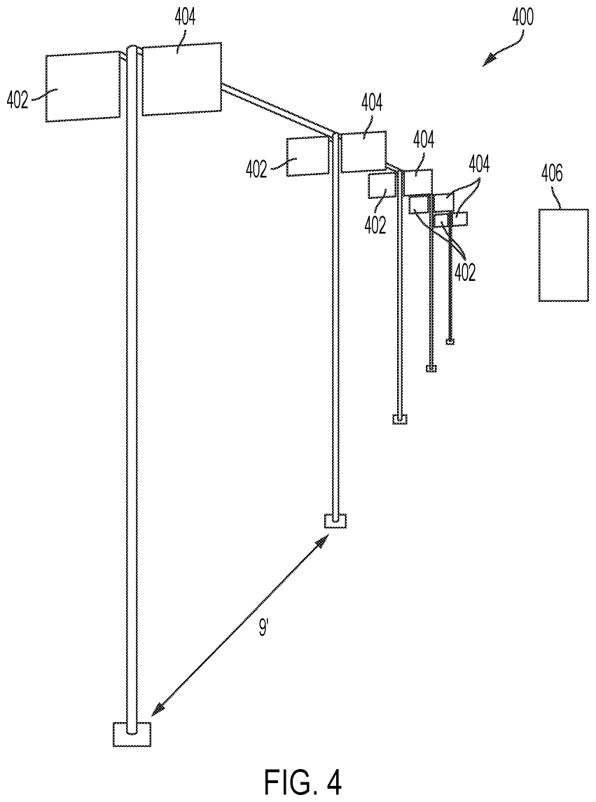

Referring now to FIG. 4, one non-exclusive example of a plurality of passenger organization displays 400 is illustrated. The plurality of passenger organization displays 400 may have a first side 402 and a second side 404. Further, in one non-exclusive embodiment there may be five passengers organization displays 400 spaced about nine (9) feet from one another. The passenger organization displays 400 may have screens on either side 402, 404 for displaying group and order information. The screens may be any known device capable of displaying text or other information. Accordingly, this disclosure considers implementing any known type of screen. Further still, in one embodiment the displays 400 may not be screens at all but rather cards or the like that have information printed thereon.

In use, the passenger organization displays 400 are intended to display the next two groups to board the vehicle 102 along with order information within the groups. Passengers in a first group are intended to line up on the first side 402 according to the order shown on the corresponding passenger display 400. Similarly, passengers of a second group are intended to line up on the second side 404 according to the order shown on the corresponding passenger display 400. Once the vehicle 102 is ready, the first group from the first side 402 will be dismissed to the vehicle 102 through an entryway 406 or the like. Once the first group is dismissed to the vehicle 102, the passenger displays 400 for the first side 402 will be modified to show the order details for a third group. Once the first group has boarded the vehicle, the second group of the second side 404 will be dismissed to board the vehicle 102. Once the second group is dismissed, the second side 404 of displays 400 may be modified to show the order details for a fourth group. This alternating process can be continued for any number of groups, and the embodiments discussed herein are meant only as non-exclusive examples.

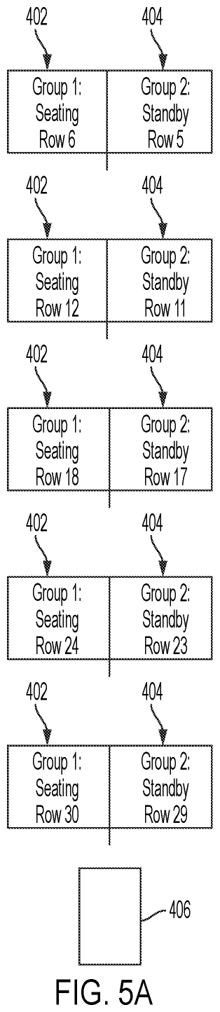

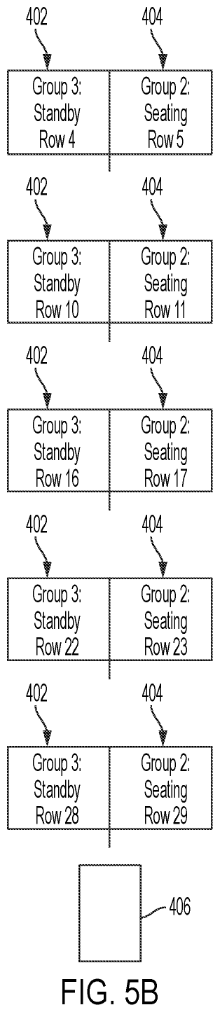

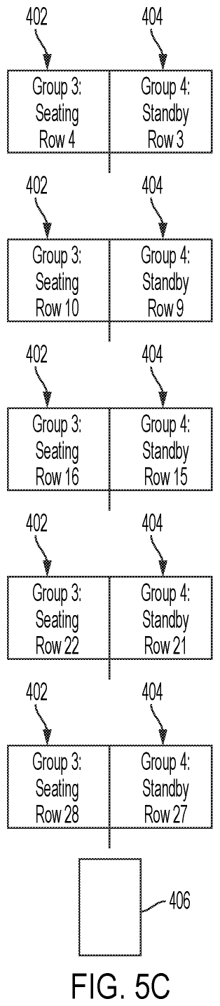

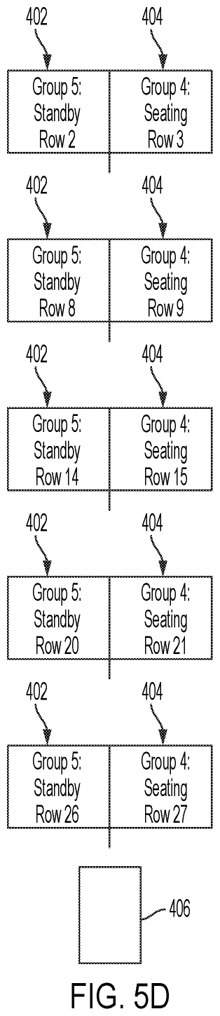

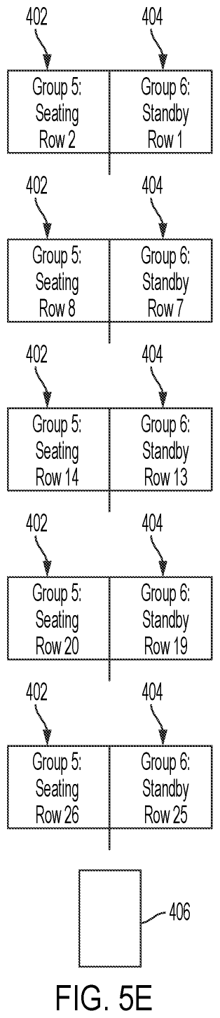

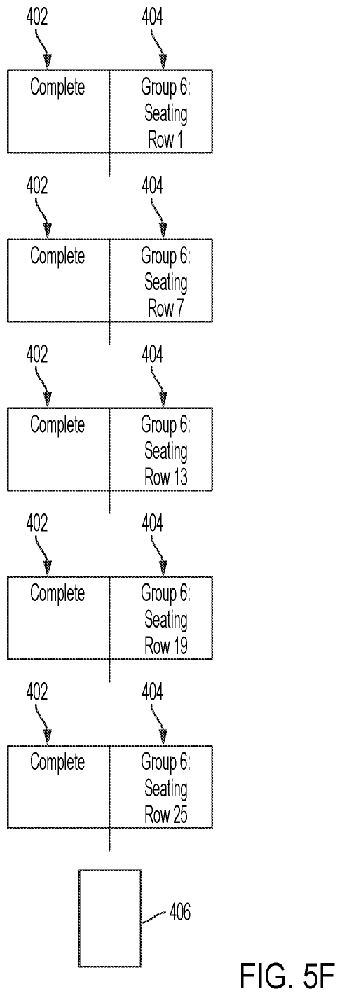

Referring now to FIGS. 5a-5f, one example of alternating information on the displays 400 is illustrated. More specifically, FIG. 5a may show an example of the information on the displays 400 when the vehicle 100 is empty and ready to board. In FIG. 5a, the first side 402 my show that group 1 is to be lined up on the first side 402. Further, the order of the passengers of group 1 may be illustrated to ensure that the passengers in the rows furthest from the vehicle boarding entrance 108 of group 1 are the first to enter the vehicle and the passengers in rows nearest to the vehicle boarding entrance 108 of group 1 are the last of the group to enter the vehicle 100. Once the passengers of group 1 are on the first side 402 and in the proper order, they may be allowed to enter the vehicle 102 via the entryway 406.

While or before the passengers in group 1 are entering the vehicle 102, the displays 400 on the second side 404 may call for passengers of group 2 to line up on the second side in a displayed second order. The second order may also organize the passengers of group 2 in the rows furthest from the vehicle boarding entrance 108 of the group to enter the vehicle 102 first. Once all of the passengers from group 1 have cleared the first side 402, the displays 400 on the first side 402 may be altered to show group 3 along with the desired passenger order of the group (see FIG. 5b). Accordingly, the passengers from group 3 may begin organizing on the first side 402 once the passengers from group 1 have left.

Once the passengers from group 1 have entered the vehicle 102, the passengers from group 2 may be dismissed from the second side 404 in the proper order to begin boarding the vehicle 102. Then, the displays on the second side 404 may be modified to show group 4 along with the proper corresponding order (see FIG. 5c). Passengers in group 4 may then begin to occupy the second side 404. This process is continued as each group from one display side is released to enter the vehicle, the corresponding displays may be altered to show the next group and order on the list (see FIGS. 5d-5f) until substantially all of the seats to be occupied are filled.

As illustrated in FIGS. 5a-5f, the displays may alternate groups and orders once the corresponding side has been cleared of the prior group. This process can be implemented for any number of groups and is not limited to the particular number of groups discussed herein.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations).

What is claimed is:

1. A method for boarding passengers on a vehicle, comprising:
providing an organization area and a passenger vehicle, the passenger vehicle having a plurality of rows between a front row and a back row;
positioning a passenger display in the organization area;
displaying, on the passenger display, a boarding pattern identifying a first group and a second group for boarding passengers onto the passenger vehicle; and
instructing passengers to exit the organization area and enter the passenger vehicle in the boarding pattern identified by the passenger display;
wherein, the first group is directed to occupy a first set of rows before the second group is directed to occupy a second set of rows;
further wherein, two adjacent rows of the first set of rows are separated from one another by at least one row of the second set of rows.

2. The method of claim 1, further wherein the first set of rows are substantially evenly spaced from one another between the front row and the back row.

3. The method of claim 2, further wherein the second set of rows are substantially evenly spaced from one another between the front row and the back row.

4. The method of claim 3, further wherein the first and second set of rows are spaced from one another to have the same number of rows positioned between adjacent rows of the corresponding first and second set of rows.

5. The method of claim 1, further wherein the boarding pattern instructs all passengers of the first group to board the passenger vehicle through a vehicle boarding entrance before instructing the second group to board the passenger vehicle.

6. The method of claim 1, further wherein the first group is arranged in a first order so a first passenger of the first group on the passenger vehicle occupies at least one seat in a row furthest from the vehicle boarding entrance of the first group.

7. The method of claim 6, further wherein the first order further organizes the remaining passengers of the first group so passengers in rows of the first set of rows biased towards the row furthest from the vehicle boarding entrance enter the passenger vehicle before passengers in rows biased nearest the vehicle boarding entrance.

8. The method of claim 7, further wherein the second group is arranged in a second order so a first passenger of the second group on the passenger vehicle occupies at least one seat in the row furthest from the vehicle boarding entrance of the second group.

9. The method of claim 8, further wherein the second order further organizes the remaining passengers of the second group so passengers in rows of the second set of rows biased towards the row furthest from the vehicle boarding entrance enter the passenger vehicle before passengers in rows biased towards the row nearest the vehicle boarding entrance.

10. The method of claim 1, further wherein a row from the second set of rows is positioned between each adjacent set of rows of the first set of rows.

11. The method of claim 1, further wherein the boarding pattern includes a third group having a third set of rows for boarding passengers onto the passenger vehicle.

12. The method of claim 11, further wherein a row from the third set of rows is positioned between each adjacent set of rows of the first set of rows.

13. The method of claim 11, further wherein the boarding pattern includes a fourth group, a fifth group, and a sixth group for boarding passengers onto the passenger vehicle.

14. The method of claim 13, further wherein the boarding pattern is arranged such that the first group boards the passenger vehicle, then the second group boards the passenger vehicle, then the third group boards the passenger vehicle, then the fourth group boards the passenger vehicle, then the fifth group boards the passenger vehicle, and finally the sixth group boards the passenger vehicle.

15. The method of claim 1, further wherein the passenger display has a first side and a second side, wherein the first side identifies the first group and the second side identifies the second group thereby instructing passengers from the first group to organize along the first side and passengers from the second group to organize on the second side.

16. The method of claim 15, further wherein the passenger display displays a first order associated with the first group on the first side and a second order associated with the second group on the second side; wherein both the first and second orders are arranged so passengers in rows further from the vehicle boarding entrance enter before passengers in rows towards the vehicle boarding entrance.

17. The method of claim 16, further wherein the boarding pattern includes a third group having a third order for boarding passengers onto the passenger vehicle and the passenger display displays the third group and third order on the first side after the first group has substantially boarded the passenger vehicle.

18. The method of claim 17, further wherein the boarding pattern includes a fourth group having a fourth order for boarding passengers onto the passenger vehicle and the passenger display displays the fourth group and fourth order on the second side after the second group has substantially boarded the passenger vehicle.

19. The method of claim 18, further wherein the boarding pattern includes additional groups that are displayed on the passenger display in an alternating pattern as subsequent groups board the passenger vehicle.
